(19) United States
(12) Patent Application Publication
(10) Pub. No.: US 2015/0379440 A1
(43) Pub. Date: Dec. 31, 2015

(54) DYNAMIC ORGANIZATION INFORMATION PRESENTATION

(71) Applicant: Prolifiq Software Inc., Beaverton, OR (US)

(72) Inventors: Hemingway Huynh, Salem, OR (US); Anh Huynh, Tigard, OR (US); Isabella Wong, Bellevue, WA (US); Jeffrey Michael Farnsworth, Portland, OR (US)

(21) Appl. No.: 14/752,743

(22) Filed: Jun. 26, 2015

Related U.S. Application Data
(60) Provisional application No. 62/018,492, filed on Jun. 27, 2014.

(51) Int. Cl. G06Q 10/06

(52) U.S. Cl. CPC G06Q 10/063

(57) ABSTRACT

Methods, apparatuses, systems, and computer-readable media for presenting directory information relating to an organization are described. A Dynamic Directory System (“DDS”) may receive information relating to an organization from various sources, including feeds, user-input information, and publicly available information. The DDS may provide dynamically updated information about associates and entities relating to the organization. The DDS may provide hierarchical and demographic information relating to associates in the organization. The DDS may provide a hierarchical presentation that illustrates relationships within the organization. The DDS may be configured to present demographic information. When an entity or associate is selected, the DDS may provide information about one or more other associates which have had interactions with that entity or associate. If a client is selected, the DDS may present associates that have had interactions with that particular client or associated assigned to that client, as well as a history client-related interactions.

### CROSS-REFERENCE TO RELATED APPLICATION

This application claims the benefit of: 1) U.S. Provisional Application No. 62/018,492, filed Jun. 27, 2014, and entitled “DYNAMIC ORGANIZATION INFORMATION PRESENTATION”, which is incorporated herein by reference in its entirety.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Many organizations, such as corporations, partnerships, non-profits, etc., are faced with institutional challenges as they grow. In particular, employee and associate information can prove very difficult to manage and keep current as organizations increase their size. For example, as additional people are brought into an organization, the organization may find it increasingly difficult to keep track of interactions and responsibilities between organization members/employees. It may thus be difficult for a first employee, when looking for information about a second employee, to determine who are the second employees supervisors, colleagues, reports, etc. Additionally, when external communications, such as with vendors or clients, are included, the problem can increase seemingly exponentially. Colleagues may find themselves contacting the same client (or potential client) with no knowledge of previous contacts that have been made with that person. Existing systems for providing information about these relationships may prove difficult to navigate, may contain outdated information, or may not present needed information at all.

### DETAILED DESCRIPTION

Embodiments will be readily understood by the following detailed description in conjunction with the accompanying drawings. To facilitate this description, like reference numerals designate like structural elements. Embodiments are illustrated by way of example, and not by way of limitation, in the Figs. of the accompanying drawings.

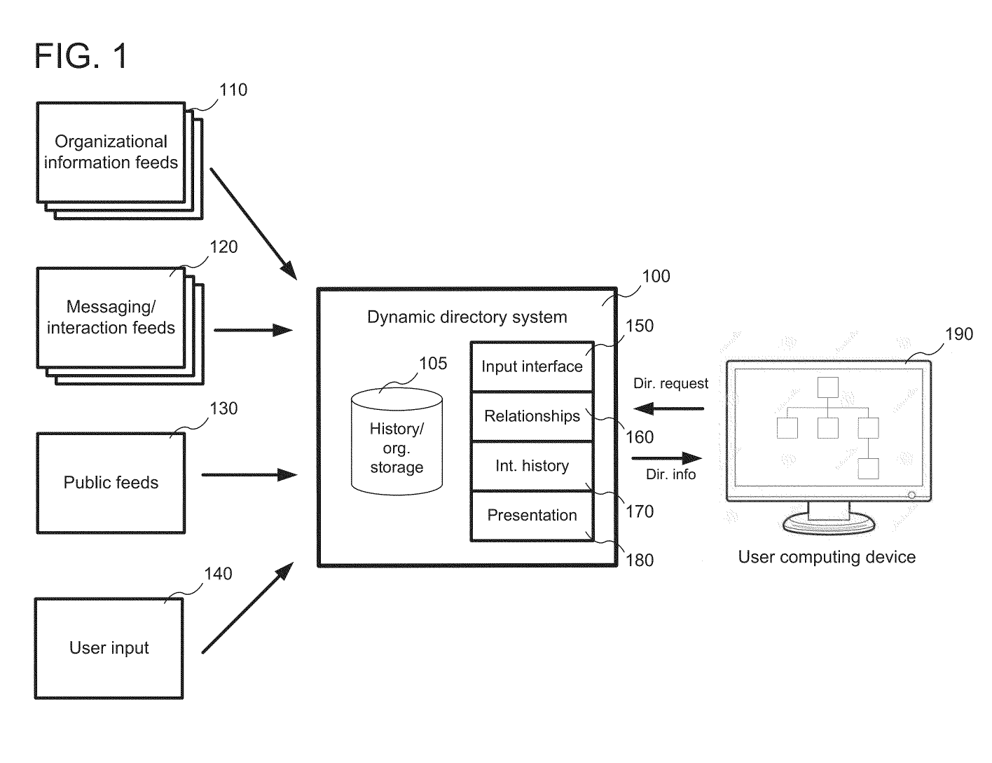

FIG. 1 illustrates an arrangement for presenting dynamic directory information, in accordance with various embodiments.

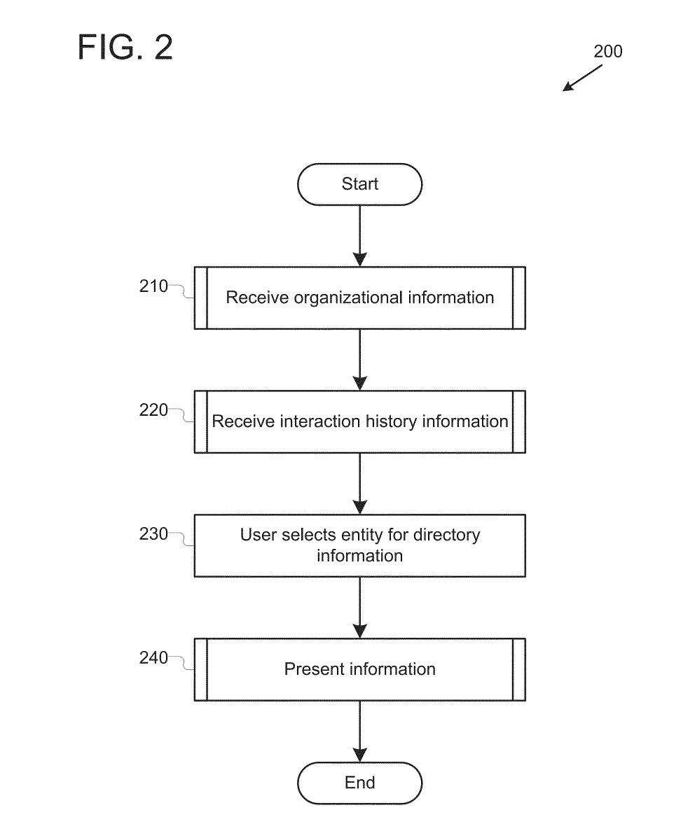

FIG. 2 illustrates an example process for presenting dynamic directory information to a user, in accordance with various embodiments.

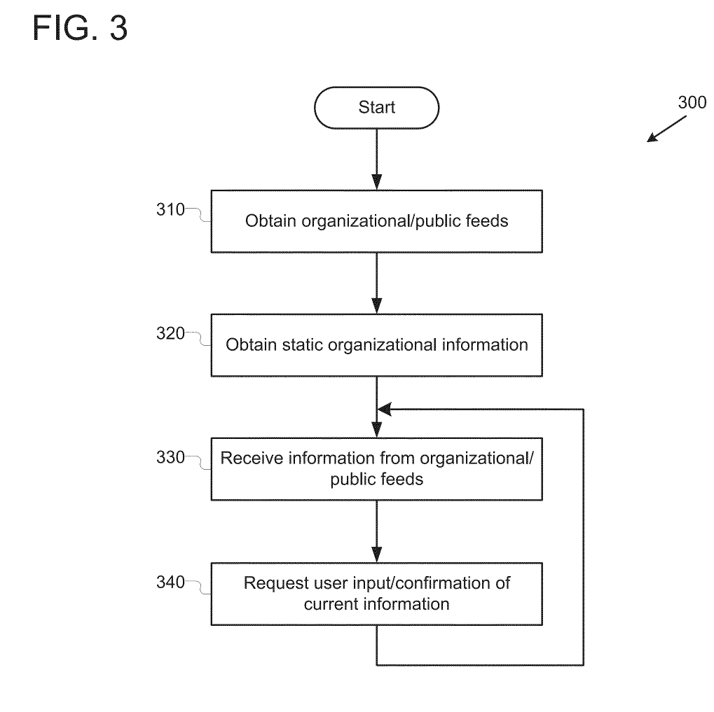

FIG. 3 illustrates an example process for receiving organizational information, in accordance with various embodiments.

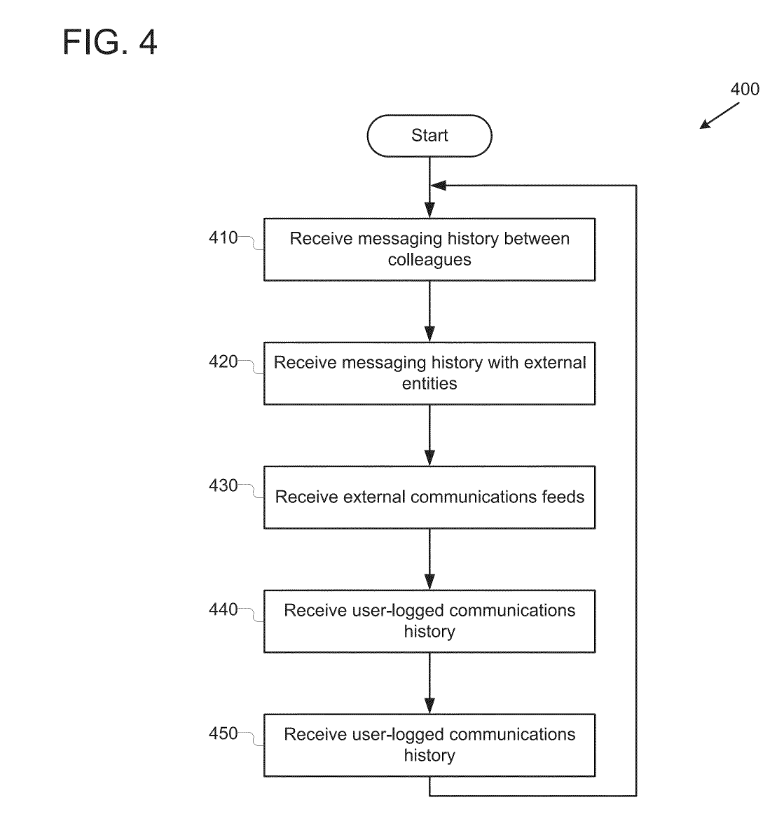

FIG. 4 illustrates an example process for receiving interaction history information, in accordance with various embodiments.

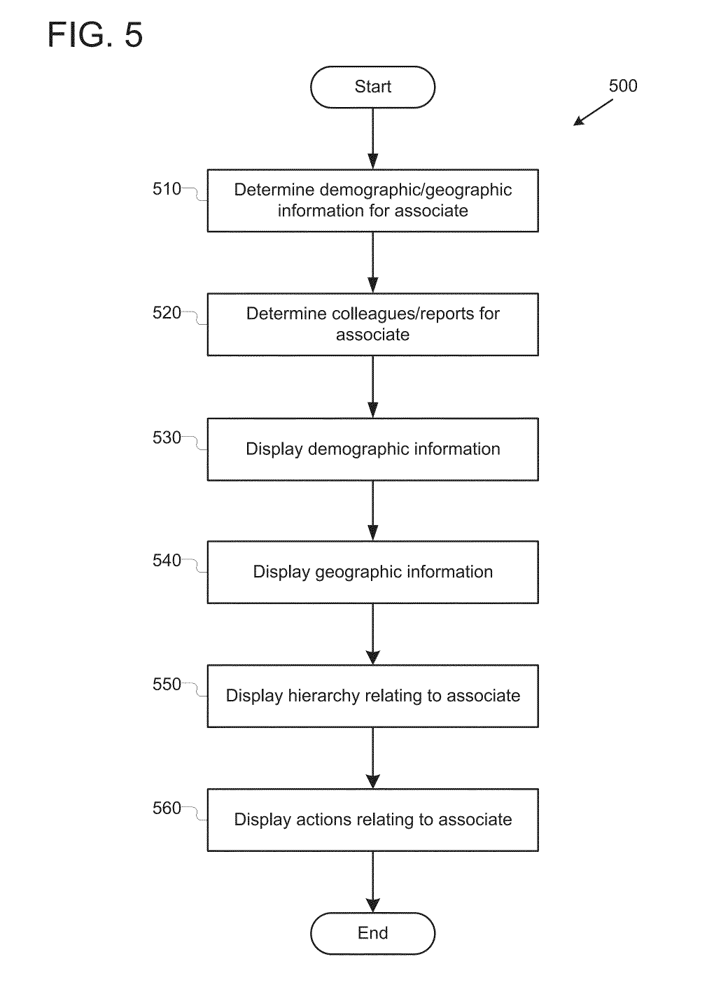

FIG. 5 illustrates a first example process for presenting directory information, in accordance with various embodiments.

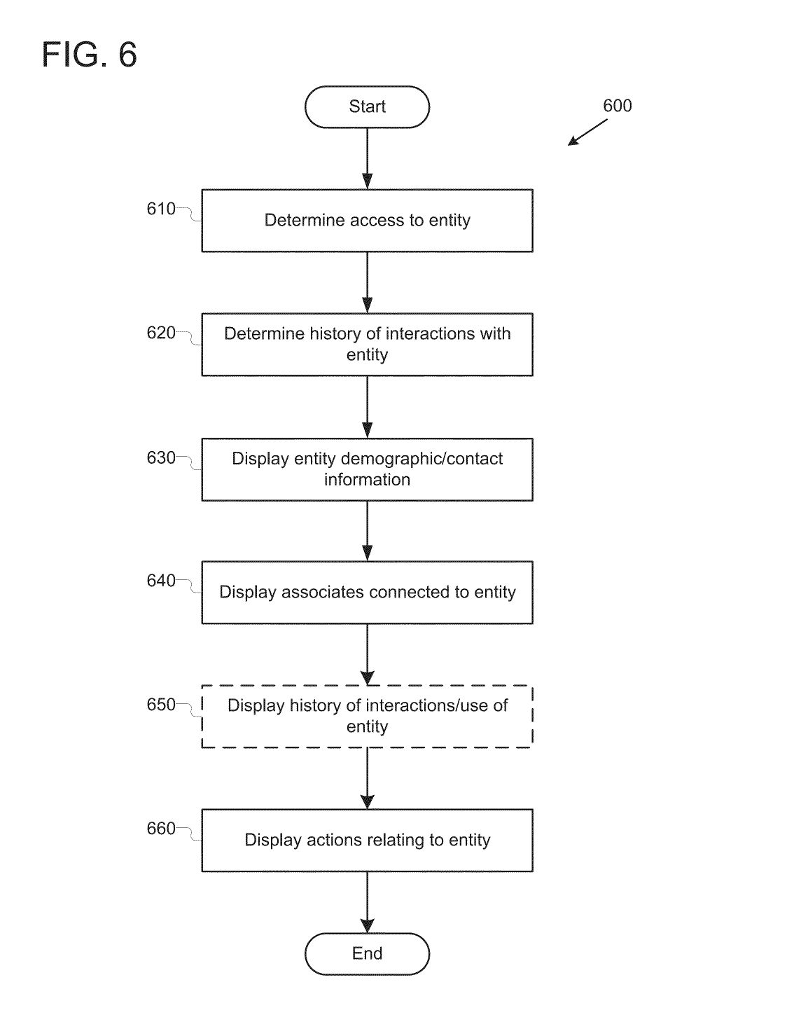

FIG. 6 illustrates a second example process for presenting directory information, in accordance with various embodiments.

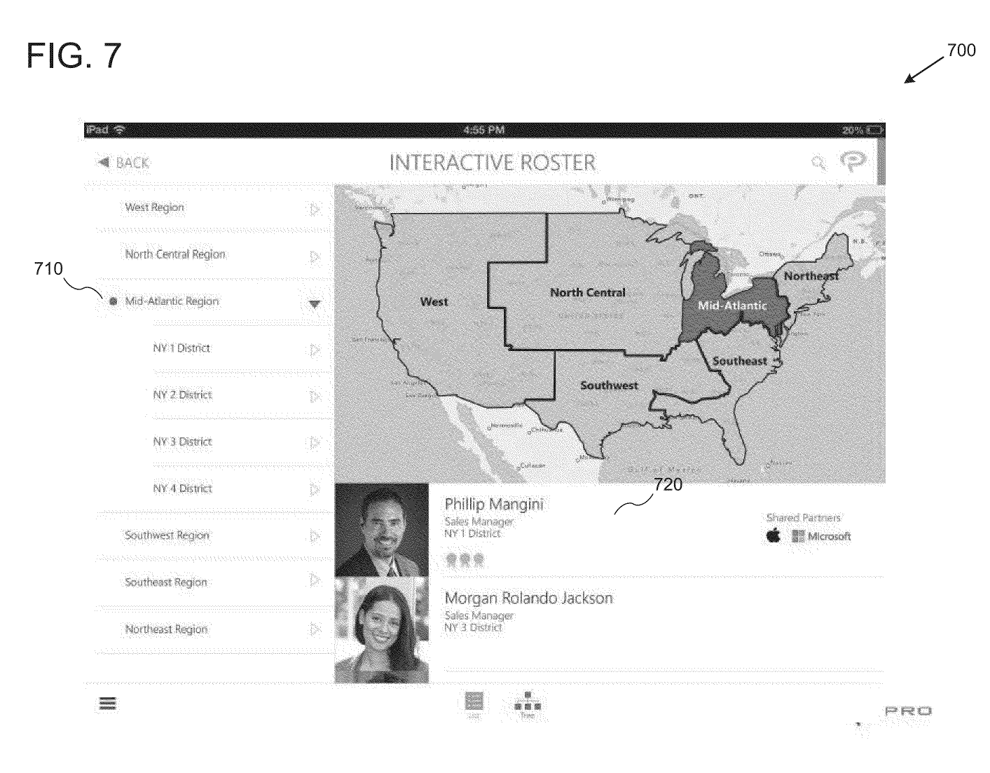

FIGS. 7-18 illustrate example interfaces of a publisher device used to present dynamic directory information, in accordance with various embodiments.

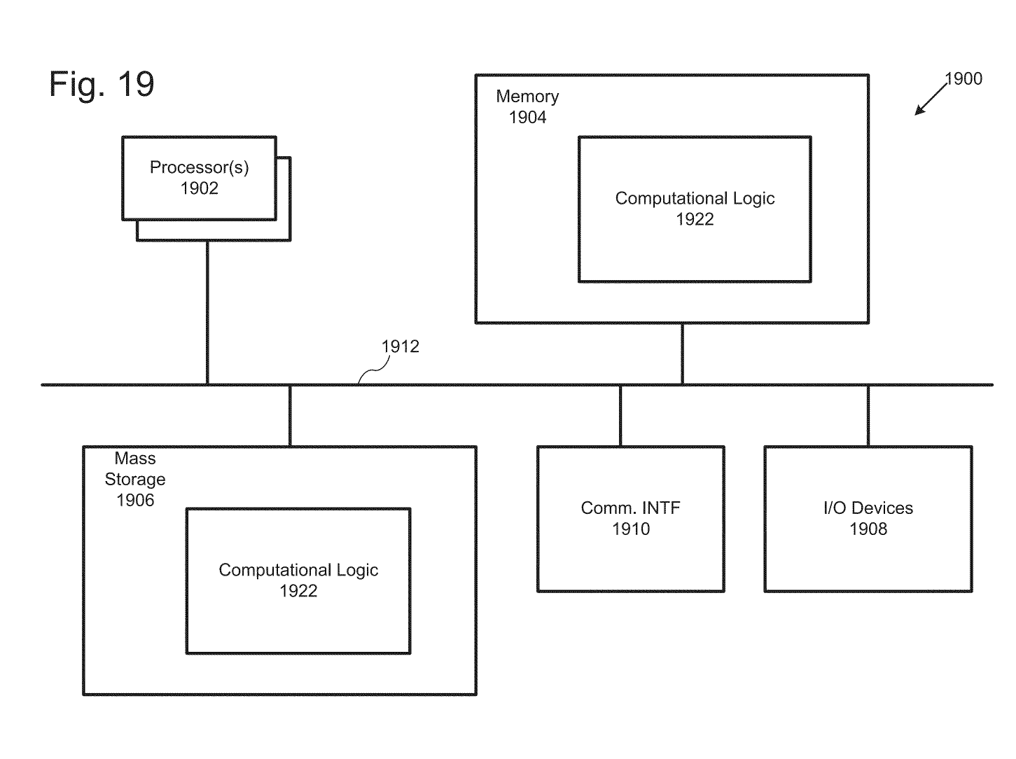

FIG. 19 illustrates an example computing environment suitable for practicing various aspects of the present disclosure in accordance with various embodiments.

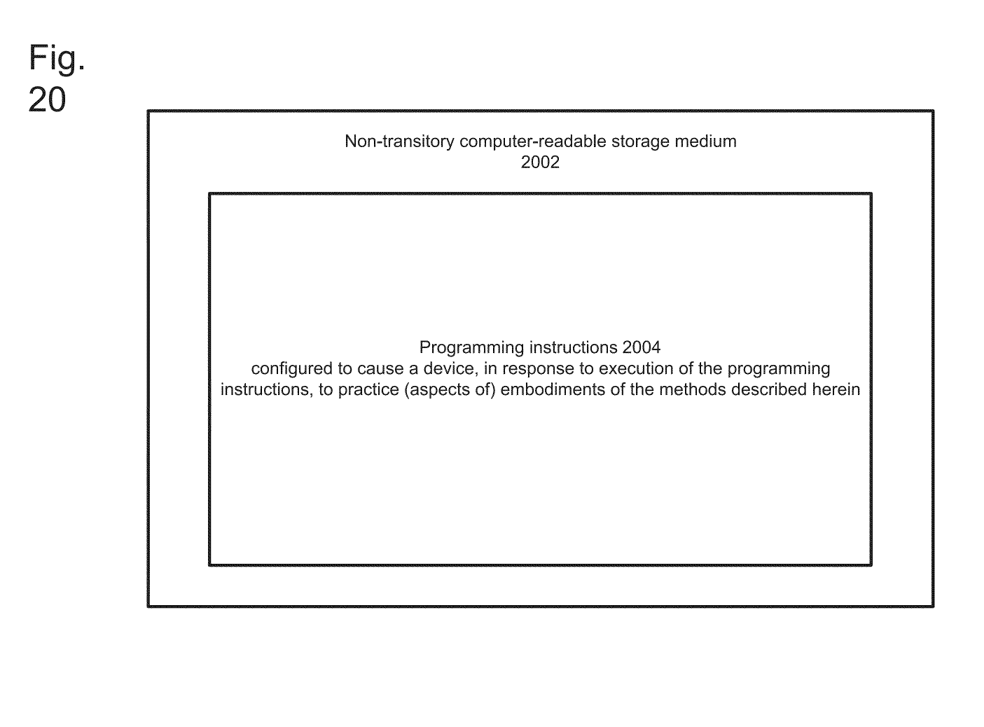

FIG. 20 illustrates an example storage medium with instructions configured to enable an apparatus to practice various aspects of the present disclosure in accordance with various embodiments.

### DETAILED DESCRIPTION

Embodiments described herein are directed to, for example, methods, apparatuses, systems, and computer-readable media for presenting directory information relating to an organization. In various embodiments, a Dynamic Directory System (“DDS”) may be configured to receive information relating to an organization, such as a corporation, non-profit, professional association, etc. The DDS may be configured to obtain information from various sources, including feeds that may provide information relating to the organization, user-input information, publicly available information, etc. In various embodiments, the DDS may be configured to provide dynamically updated information about associates and entities relating to the organization. In various embodiments, associates may include various persons associated with operations, workflows, and/or activities of the organization, such as, for example, employees, managers, executives, contractors, clients, contacts, etc. In various embodiments, some of these entities may be external to the organization. In various embodiments, entities may include non-person entities, such as geographical designations, organizational divisions, client companies that are not part of the organization, information from social networks, etc. In some embodiments, entities may also include applications, pieces of information, and/or collections of information which are limited in their accessibility and for which particular associates may have been granted access.

In various embodiments, the information that may be presented to a user by the DDS may be received from various sources. In some embodiments, the information may be received from one or more organizational information feeds, which may provide demographic and structural information that may be dynamically updateable, such as by managers or a human resources department. In other embodiments, the DDS may be provided with user-input information, such as if organizational feeds are not available, or if updated or corrected information is desired to be provided by particular individuals. In yet other embodiments, the DDS may be provided with feeds describing interactions between associates and other associates and/or with outside entities.

In various embodiments, the DDS may be configured to provide hierarchical and demographic information relating to associates in the organization. In such embodiments, when information relating to an associate is requested by a user, the DDS may be configured to provide a hierarchical presentation that illustrates relationships within the organization between the selected associated an others within the organization. In other embodiments, the DDS may be configured to present information relating to contact, biographical, experiential, or other information relating to the selected associate. This information may be referred to herein as “demographic information” for the purposes of simplified description.

In various embodiments, when an entity or associate is selected, the DDS may be configured to provide information about one or more associates which are associated with or others which have had interactions with that entity or associate. For example, if a geographical region or office is selected, the DDS may be configured to present information relating to those associates that are located or assigned to the geographical region or office, or, alternatively or in addition, those associates assigned to work with clients or other contacts within geographical region. Thus, if a region were to be selected, the DDS may illustrate a group of sales representatives that are assigned to work within the selected region. In another example, the DDS may be configured to provide information relating to proximity information for an associate, such as all associates that are located within a requested distance from the selected associate. In various embodiments, this proximity information may be determined without reference to geographically related assignments, such as those discussed above. In yet another example, if a client is selected, the DDS may be configured to present those associates that have had interactions with that particular client, as well as a history of such interactions.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Referring now to FIG. 1, an arrangement for presenting dynamic directory information is illustrated in accordance with various embodiments. As shown in FIG. 1, a Dynamic Directory System 100 (“DDS 100”) may receive information from a variety of sources. For example, in some embodiments, an organization associated with the DDS 100 may provide one or more organizational information feeds 110. These organizational information feeds 110, which may be implanted using various technologies as may be understood, may provide demographic and structural information that may be reviewed periodically by the DDS 100. For example, an RSS feed may provide a dynamically updated XML structure for associates in the organization, and may be reviewable by the DDS 100 such that the DDS 100 may have up-to-date information about working relationships between associates in the organization. In other embodiments, DDS 100 may obtain information through other means, such as, for example, FTP, email, or a publicly facing API. Additionally, in various embodiments, the information may be formatted in various formats, including, but not limited to, flat files, CSV files, Excel™ or other spreadsheet formats, etc. In various embodiments, other implementations may be utilized, as will be understood. In various embodiments, the organizational information feed 110 may thus be dynamically updateable, such as by managers or a human resources department, so that up-to-date information is available to the DDS 100.

In various embodiments, as shown in FIG. 1, the DDS 100 may be provided with user input 140 information in lieu of or in addition to organizational information feeds 100. For example, if organizational feeds are not available, the DDS 100 may be configured to allow a user, such as an associate of the organization to manually input demographic and/or relationship information into the DDS 100. In other embodiments, the DDS 100 may provide a facility for users, such as associates to review and confirm or change information provided by the organizational information feeds 110. In various embodiments, such review may be provided periodically, and/or at each time information from the feed is changed. In other embodiments the user may provide information to supplement the data provided by the organizational information feeds 110. In other embodiments, the user may provide actions, which may include required actions, or suggested or recommended actions, for performance by associates or other entities. In various embodiments, these actions may be associated with the user by information, assets (such as videos, images, PDFs, documents, etc.) or tools that may be used for performance of the action. In various embodiments, action may be associated with associates, such as associates that are to perform the actions, and/or other entities, such as entities for whom the actions should be performed.

In other embodiments, other information may be provided to the DDS 100. For example, the DDS 100 may be configured to receive information from provided with one or more messaging/interaction feeds 120 which describe interactions between associates and other associates and/or with outside entities. In various embodiments, the messaging/interaction feeds 120 may provide actual content of messages exchanged between associates, and/or between associates and entities outside of the organization. In other embodiments, the DDS 100 may receive, from the messaging/interaction feeds 120, limited information related to messages or interactions, such as time and/or type information. In this manner, the DDS 100 may receive information that demonstrates that interactions were made between associates or between associates and entities without knowing the particular content of the interactions. Finally, in some embodiments, the DDS 100 may be configured to receive information from public feeds 130, such as publicly available databases, websites, information provided by entities not associated with the organization, etc.

In various embodiments, the DDS 100 may include one or more modules and/or stores that may facilitate activities describe herein. While FIG. 1 illustrates particular modules, in various embodiments, the modules illustrated may be merged, divided further, or omitted altogether. Additionally, while particular activities are described with respect to the modules of FIG. 1, in various embodiments, other activities may be performed, and/or illustrated or described activities may be omitted. Additionally, while FIG. 1 illustrates various embodiments, as being contained in the DDS 100, in various embodiments, the modules illustrated may be implemented and may operate on separate computing devices. For example, a presentation module (described below) may operate on a tablet or other mobile device and may communicate with one or more of the other modules implemented on a separate computing device. These modules may communicate via a wired or wireless network (such as infrared, Bluetooth or Wi-fi) in order to perform one or more activities described herein.

In various embodiments, the DDS 100 may include a history/organization information storage module 105 (“HIS 105”) which may be configured to store information received from, for example, one or more of the organization and associate information sources described above. The HIS 105 may be implemented according to known techniques, as will be understood. In various embodiments, the DDS 100 may include an Input Interface Module 150 (“IM 150”) which may be configured to receive information from one or more information sources and to store the information in the HIS 105. In various embodiments, the IM 150 may be configured to poll one or more organizational information feeds 110 and/or public feeds 130 to receive information relating to the organization. In other embodiments, the IM 150 may be configured to provide one or more interfaces through which one or more users may provide input, such as by providing organizational information that is not provided by an organizational information feed 110. In other embodiments, the IM 150 may be configured to display information received from other sources to a user and to receive corrections or additional information from a user. In various embodiments, the IM 150 may also include one or more Application Programming Interfaces (APIs) or other interfaces through which information may be received by the DDS 100. In various embodiments, the HIS 105 may be configured to store actions for performance by associates, as described herein.

In various embodiments, the DDS 100 may also include a relationships module 160 (“RM 160”) which may be configured to maintain information relating to relationships between associates or between associates and entities and to provide this information for presentation to a user. For example, in various embodiments, the RM 160 may be configured to maintain hierarchical information for associates, such as supervisory or reporting relationships between associates, information relating to one or more teams or task forces associates may be associated with, associate co-location within an office or a geographical region, etc.

In various embodiments, the DDS 100 may include an Interaction History Module (“IHM 170”) which may be configured to maintain history of interaction information. For example, in some embodiments, the IHM 170 may maintain a history (or histories) of interaction between associates, such as emails, messaging, phone calls, etc. In other embodiments, the IHM 170 may maintain a history (or histories) of interaction between associates and other entities, such as clients. In various embodiments, this interaction information may be received through messaging/interaction feeds 120, or may be directly reported by one or more associates. As discussed above, in various embodiments, the history maintained by the IHM 170 may include actual content of interactions; such content may include complete records of interactions. In other embodiments, more limited information may be maintained, such as, for example, only time/place/type information, or some subset or superset thereof. In various embodiments, the history may be provided by modules in the DDS 100, other systems that are configured to interact with the DDS 100, or may be input by users.

In the DDS 100 may include a Presentation Module 180 (“PM 180”) which may be configured to present directory information to a user, such as at the user computing device. In various embodiments, the PM 180 may present information on a user computer device 190, such as the illustrated desktop computer, or a laptop or mobile computing device (not illustrated). In various embodiments, the PM 180 may be configured to present hierarchical information illustrating relationships between associates, such as by showing a tree view of working relationships between associates (an example of which is illustrated in FIG. 1). In other embodiments, the PM 180 may be configured to present information illustrating relationships between associates and customers, such as health care professionals. In various embodiments, the PM 180 may also be configured to provide demographic information, interaction history, and/or other information. In various embodiments, the PM 180 may be configured to receive input from a user, such as a selection of an associate, a geographic region, a client, a customer, a provider, or other entity, etc., and to provide particularized information relating to the selected entity or associate. Particular examples of interfaces provided by the PM 180 are given below.

Referring now to FIG. 2, an example process 200 for presenting dynamic directory information to a user is illustrated in accordance with various embodiments. While FIG. 2 illustrates particular example operations, in various embodiments, the process may include additional operations, omit illustrated operations, and/or combine illustrated operations. The process may begin at operation 210, where the DDS 100, and in particular the IM 150, may receive organizational information. Particular implementations of this operation are described below with reference to FIG. 3. Next, at operation 220 the DDS 100 may receive interaction history information. Particular implementations of this operation are described below with reference to FIG. 4. Next, at operation 230, a user, such as an associate of the organization or outside user, may select an entity (or associate) to view directory information for that entity (or associate). Next, at operation 240, the DDS 100, and in particular the PM 180, may present directory information to the user. Particular implementations of this operation are described below with reference to FIGS. 5 and 6. The process may then end.

Referring now to FIG. 3, an example process 300 for receiving organizational information is illustrated in accordance with various embodiments. In various embodiments, process 300 may implement one or more embodiments of operation 210 of process 200. While FIG. 3 illustrates particular example operations, in various embodiments, the process may include additional operations, omit illustrated operations, and/or combine illustrated operations. The process may begin at operation 310 where the IM 150 may obtain information relating to organizational information feeds 110 or public feeds 130. For example, the IM 150 may receive addresses for one or more feeds for the organizational information feeds 110 or public feeds 130. In some embodiments, no feed information may be available or provided to the IM 150, and only static or user-input information 140 may be received by the IM 150.

At operation 320, the IM 150 may receive static organizational information. In various embodiments, this static organizational information may include one or more files or data structures that statically describe the organization, such as job descriptions, supervisory or reporting relationships, contact information, etc. In some embodiments, such information may be taken from external or internal websites or data structures/databases of the organization, including publicly available websites of the organization that may describe associates of the organization. At operation 330 the IM 150 may receive information from the organizational information feeds 110 or public feeds 130 that were earlier obtained by the IM 150. In various embodiments the IM 150 may receive this information using the feeds according to known techniques. At operation 340 the IM 150 may request user input 140 and/or confirmation of current information. For example, in various embodiments, the IM 150 may present information that is currently known to the IM 150 and request that an associate review and approve or correct the presented information. In various embodiments, the user may or may not be an associate for which information is being presented. For example, a Human Resources manager may review information for one or more associates of an organization to ensure the correctness of the information; in other embodiments, associates themselves may review their own information. In other embodiments, users may input information to fill in gaps in information maintained by the DDS 100. Additionally, in some embodiments, user information may not be solicited or provided. After this operation, in some embodiments, the IM 150 may return to receiving information from various feeds, as illustrated. In other embodiments, the process may then end.

Referring now to FIG. 4, an example process 400 for receiving interaction history information is illustrated in accordance with various embodiments. In various embodiments, process 400 may implement one or more embodiments of operation 220 of process 200. While FIG. 4 illustrates particular example operations, in various embodiments, the process may include additional operations, omit illustrated operations, and/or combine illustrated operations. The process may begin at operation 410 where messaging history may be received between associates that are colleagues within the organization. For example, at this operation, the IM 150 may receive information relating to instant messages, emails, voice messages, information from social networks, etc. that have been sent within the organization. In various embodiments, this information may be received from one or more messaging/interaction history feeds 120. In other embodiments, such history information may be collected and recorded automatically by individual computing devices of various associates. Next, at operation 420, the IM 150 may receive information relating to instant messages, emails, voice messages, information from social networks, etc. that have been sent with external entities, such as clients, customers, knowledge professionals, etc. In various embodiments, such history information may be collected from feeds and/or from information collected at individual entity devices. In some embodiments, as well, history information may be collected from individual reports of associates or other entities.

At operation 430, the IM 150 may receive external interaction feeds. For example, the IM 150 may receive one or more examples of interaction or other interactions between associates associated with the organization and external entities, such as clients, customers, or potential customers. Again, in various embodiments, this information may be received from one or more messaging/interaction feeds 120 and/or from information automatically collected by associates' individual computing devices. Next, at operation 440, the IM 150 may receive user-logged interaction history that may not be otherwise provided by automatically-reporting feeds, such as phone call histories, or in-person interaction histories. In some embodiments, the process may then repeat, such as in a regular manner as information is updated and/or new information is added. In other embodiments, the process may then end.

Referring now to FIG. 5, a first example process 500 for presenting directory information is illustrated in accordance with various embodiments. In various embodiments, process 500 may implement one or more embodiments of operation 240 of process 200. While FIG. 5 illustrates particular example operations, in various embodiments, the process may include additional operations, omit illustrated operations, and/or combine illustrated operations. In the example of FIG. 5, a user has selected an associate for the PM 180 to present information about. The process may begin at operation 510, where the PM 180 may retrieve demographic and/or geographic information for the associate. As mentioned herein, in various embodiments, the PM 180 may determine contact information, biographical information, location information, etc. for the associate. Next, at operation 520, the PM 180 may determine colleagues and/or reports for the associate. For example, in various embodiments, the PM 180 may refer to information maintained by the RM 160 to determine which associates are colleagues and/or which people the associate reports to or is reported to. As discussed above, such information may have been previously obtained by organizational information feeds and/or user-provided information. Next, at operation 530, the PM 180 may display the determined demographic information. In various embodiments, such demographic information may be displayed as a pop-up or overlay that is specifically associated with the associate. The PM 180 may then, at operation 540, display geographic information for the associate. For example, the PM 180 may present a map (or list) of one or more regions associated with the associate. In some embodiments, the PM 180 may additionally present other associates that are co-located or otherwise associated with the same regions. Next, at operation 550, the PM 180 may present a hierarchy relating to the associate. For example, the PM 180 may present a tree illustrating reporting relationships between the associate and supervisors of the associate or people that report to the associate. Particular examples of presentation of this information are provided below. In other embodiments, other manners of presenting relationships between the associate and other associates or other entities may be utilized.

In various embodiments, at operation 560, the PM 180 may also present one or more actions that may be related to the associate. For example, the PM 180 may present actions that have been assigned to the associate, such as by other associates, or entities, for later performance. In various embodiments, these actions may include, but are not limited to, one or more of: required actions, recommended actions, automated follow-up actions, etc. In various embodiments, the actions may include one or more assets, presentations, or tools which may be suggested or required for usage when performing the actions. After presentation of actions, the process may then end.

Referring now to FIG. 6, a second example process 600 for presenting directory information is illustrated in accordance with various embodiments. In various embodiments, process 600 may implement one or more embodiments of operation 240 of process 200. While FIG. 6 illustrates particular example operations, in various embodiments, the process may include additional operations, omit illustrated operations, and/or combine illustrated operations. In the example of FIG. 6, a user has selected an entity (such as a client or an application) for the PM 180 to present information about. The process may begin at operation 610, where the RM 160 may determine which associates known to the RM 160 have access to the entity. For example, the entity, if it is an application, may not be accessible by all associates, or only by associates with particular permissions. In another example, if a entity is a client of the organization, the RM 160 may determine which associates have had interaction (or are permitted to have interaction) with the entity. Next, at operation 620, the IHM 170 may determine a history of interactions that have taken place with the entity. As discussed above, this history may be obtained from various interaction feeds, or by user-reported data. Next, at operation 630, the PM 180 may display demographic information for the entity. For example, for a client, the PM 180 may display contact information for the entity. Next, at operation 640, the PM 180 may display the associates determined to have previously interacted with the entity and/or which associates are permitted to access the entity. This may be determined through the information determined in the previous operations. In various embodiments, the PM 180 may be configured to display information according to one or more user preferences, such as by display only certain fields. In other embodiments, the organization itself may control which fields of information are displayed, or the PM 180 may be configured to display some fields as required and some fields as optional, per the preferences of the organization and/or the user. In various embodiments, at operation 640 the, PM 180 may display the associated in various orders or organizational structures, including hierarchical structures or in flat structures. In various embodiments, the associates may be ordered within the presentation according to the order, volume, or types of interactions that the associates have had with the entity. Next, at operation 650, in an optional operation, the PM 180 may display a history of interactions or use of the entity. In some embodiments, a timeline of interactions may be displayed at this interaction. In some embodiments, actual content of the interactions may be displayed.

In various embodiments, at operation 660, the PM 180 may also present one or more actions that may be related to the entity. For example, the PM 180 may present actions that have been assigned, such as to various associates by other associates or entities, for later performance with the entity. As discussed above, in various embodiments, these actions may include, but are not limited to, one or more of: required actions, recommended actions, automated follow-up actions, etc. In various embodiments, the actions may include one or more assets, presentations, or tools which may be suggested or required for usage when performing the actions. The process may then end.

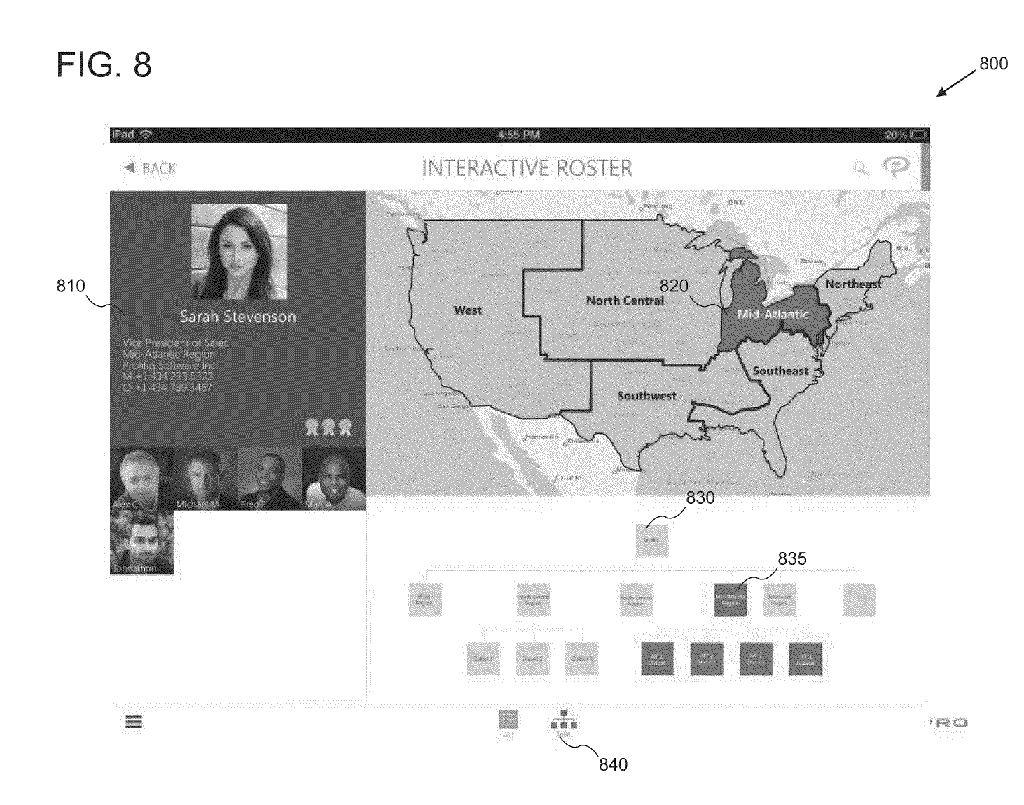

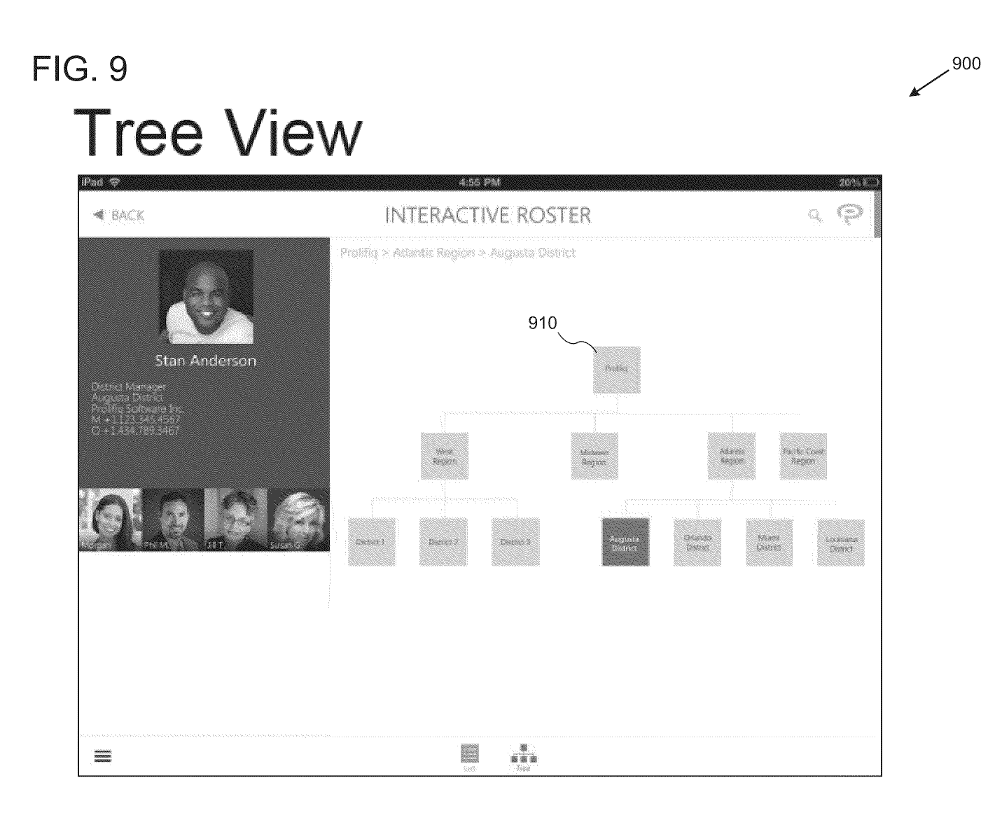

FIGS. 7-17 illustrate example interfaces of a publisher device used to present dynamic directory information. For example, in FIG. 7, an interface 700 of the PM 180 is shown where a geographic region entity has been selected by a user, in this case the “Mid-Atlantic” region of the United States 710. As illustrated in the example, a list 720 of associates who have been determined to be associated with the selected region is presented to the user. In the example interface 800 of FIG. 8, a particular associate has been selected and her demographic information 810 is displayed, along with an illustration 820 of a geographic region associated with the selected associate. Additionally, FIG. 8 shows an example tree hierarchy 830 showing the selected associate highlighted in the hierarchy of people associated with the region. The example tree hierarchy 830 also illustrates colleagues of the associate that are also associated with the region, such as the associate illustrated in node 835. In various embodiments, a user may be able to select associates using the presented tree in various manners, such as, for example, by selecting a box of the tree with a mouse or by scrolling or navigating around the tree using arrow keys, mouse scrolls, or touchpad gestures. Additionally, as illustrated with the UI elements at the bottom of FIG. 8 (as well as in FIGS. 9-12), the user may be provided a facility for choosing between a list or a tree view for associate information, such as by using controls 840. In other embodiments, other views of associate relationship information may be supported. For example, in some embodiments the PM 180 may be configured to display a selected associate in the center of a grouping of concentric circles, where each circle illustrates a group of other associates or entities that are related to the selected associate, and wherein associates or entities that are deemed more closely related, according to a various metrics, are located within closer circles.

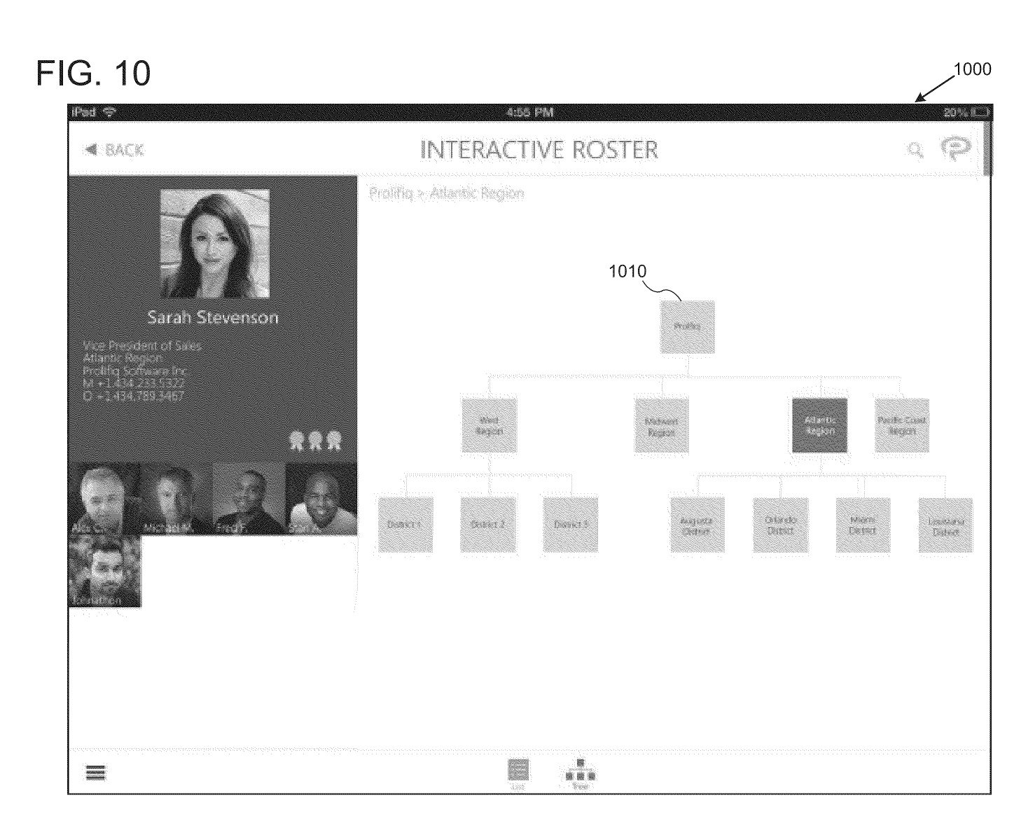

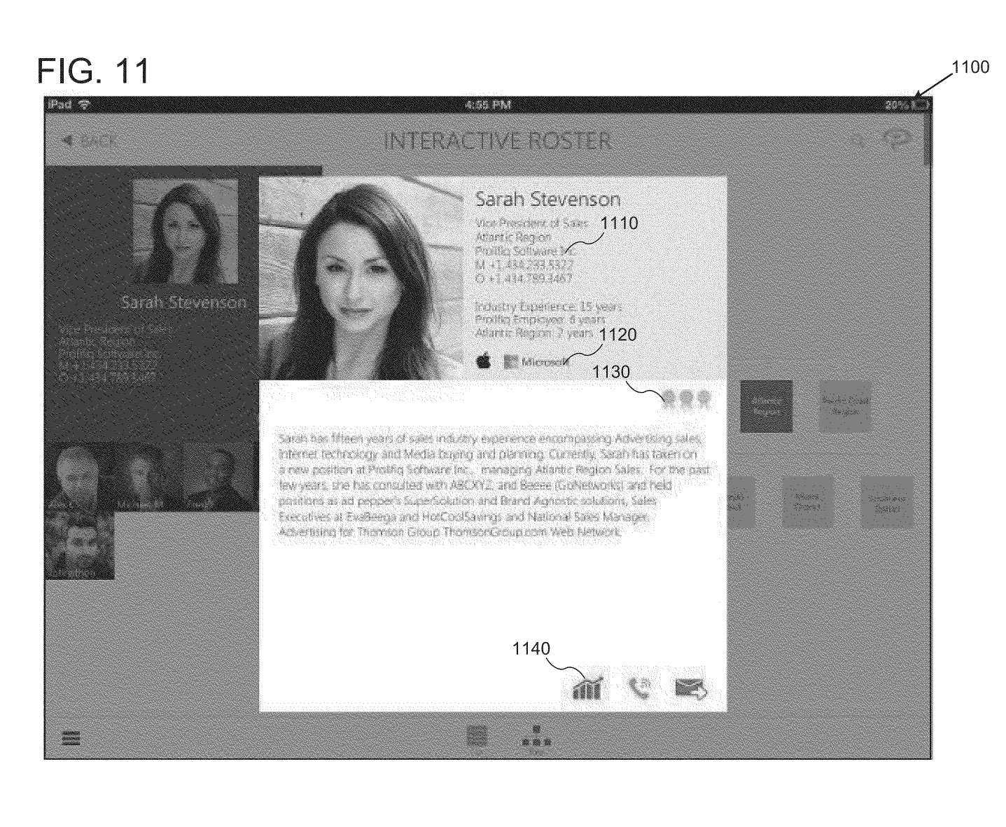

FIGS. 9 and 10 give further examples 900 and 1000 of interfaces illustrating hierarchical trees 910 and 1010, where different associates are selected. In each case, demographic information (here contact information) for the associates is presented; in some embodiments, this demographic information may be configurable by the user and/or by other users. FIG. 11 illustrates an interface 1100 where example demographic information 1110 for the selected associate, including biographical information, educational information, and contact information are shown. Additionally, FIG. 11 illustrates credentialing information 1120 about the selected associate, such as credentialing with particular companies. FIG. 11 also illustrates how badges 1130, or other awards, which may have been provided to the associate in the past, may be illustrated (e.g. the ribbons that are illustrated). FIG. 11 also illustrates controls 1140 for performing actions utilizing information associated with the user, such as generating reports about the associate (using the graph UI element), calling the associate (using the telephone UI element), or emailing the associate (using the mail UI element). In various embodiments, the PM 180 may be configured to provide extendable facilities (such as an API or other programmatic hooks) to support additional activities or actions to be performed using associate information.

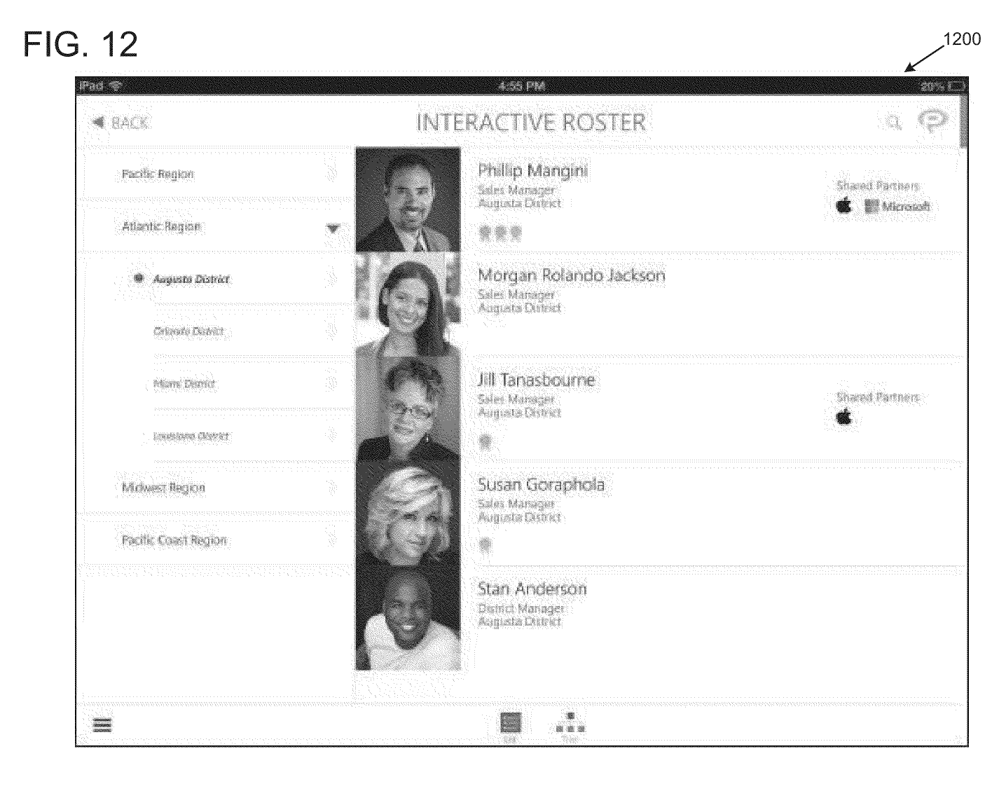

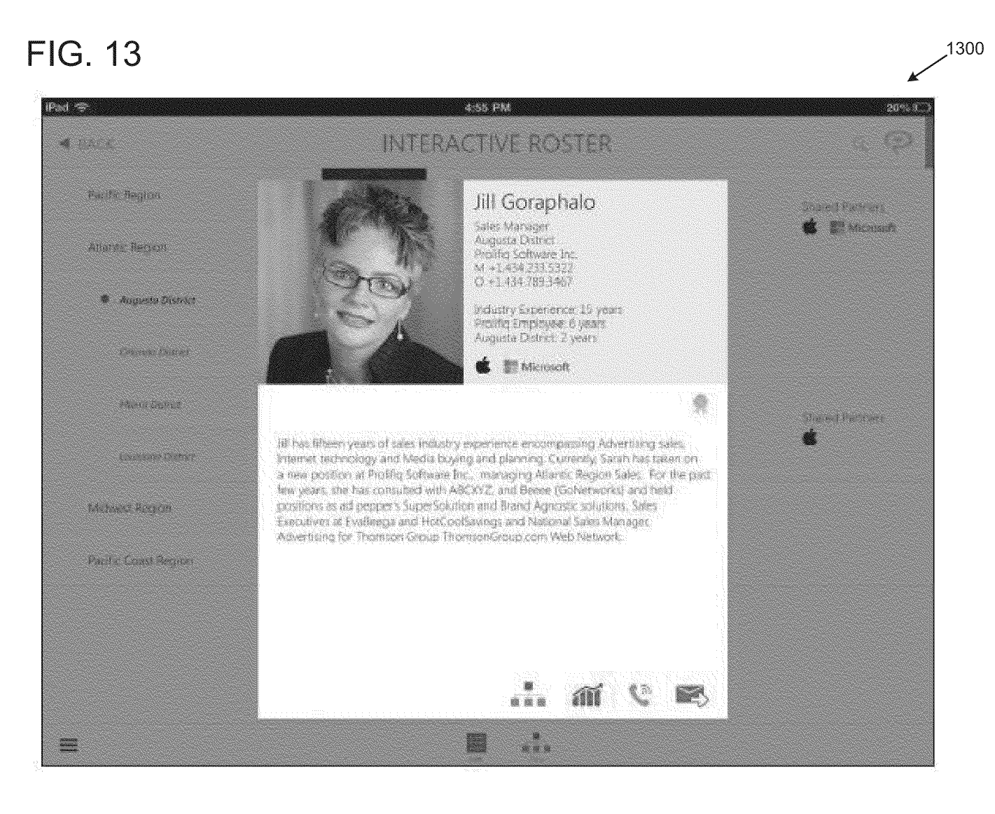

FIG. 12 illustrates a list view interface 1200 (as selected from the UI element at the bottom) where the user may view associates associated with a particular region (without illustrating a map), while FIG. 13 illustrates another interface 1300 with example demographic information for an associate selected from the list. It may also be noted that, in the examples of FIGS. 11 and 13, the PM 180 also provides links through which a user may contact the selected associate.

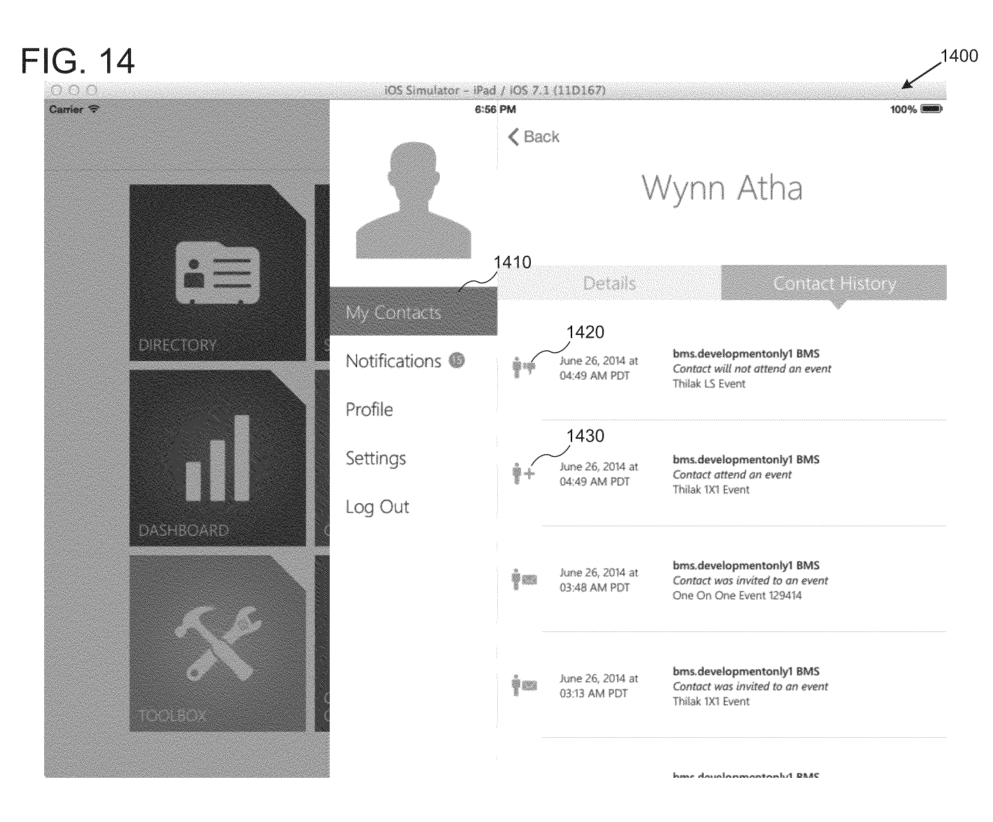

FIG. 14 illustrates an example history information view 1400, where a list 1410 of interactions (“contacts” in the example) for a particular entity is illustrated. In the example, the entity has been invited, such as through email or other messaging, to various events. In the example, the entity has refused one of the invites, and this refusal is shown with a thumbs down icon 1420. The entity has also agreed to attend an event, which is noted at 1430, and has two outstanding invitations, as shown. In various embodiments, other form factors for displaying an interaction history may be utilized. Additionally, in various embodiments, other interaction information may be utilized, such as, for example, indications of in-person interactions with associates, indications of phone calls made with the entity, and indications of content that has been viewed by the entity.

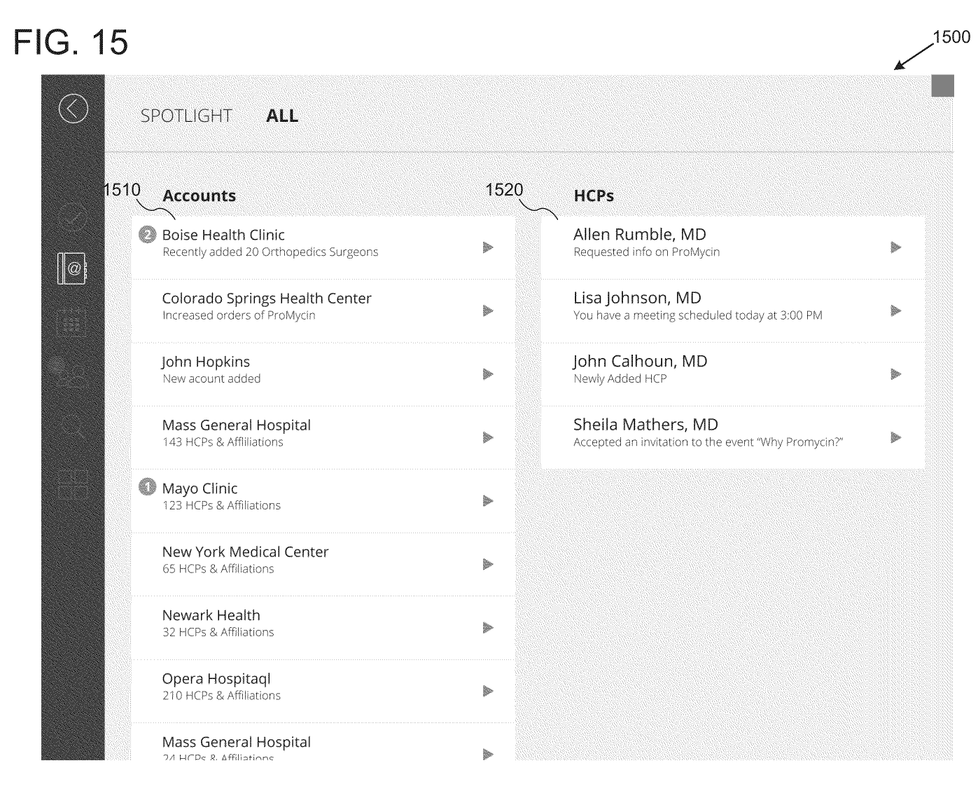

FIG. 15 illustrates an example interface 1500 for viewing entities, in this case, health care provider systems that are customers. In the example, a list 1510 of provider systems is presented. One of these, Mayo Clinic, has been selected, and the PM 180 has presented a list 1520 of health care providers that are associated with that provider system. Associated with each health care provider in the list is an indication, such as indication 1525, of a recent interaction performed with the health care provider or a status of the health care provider (e.g., “newly added HCP”).

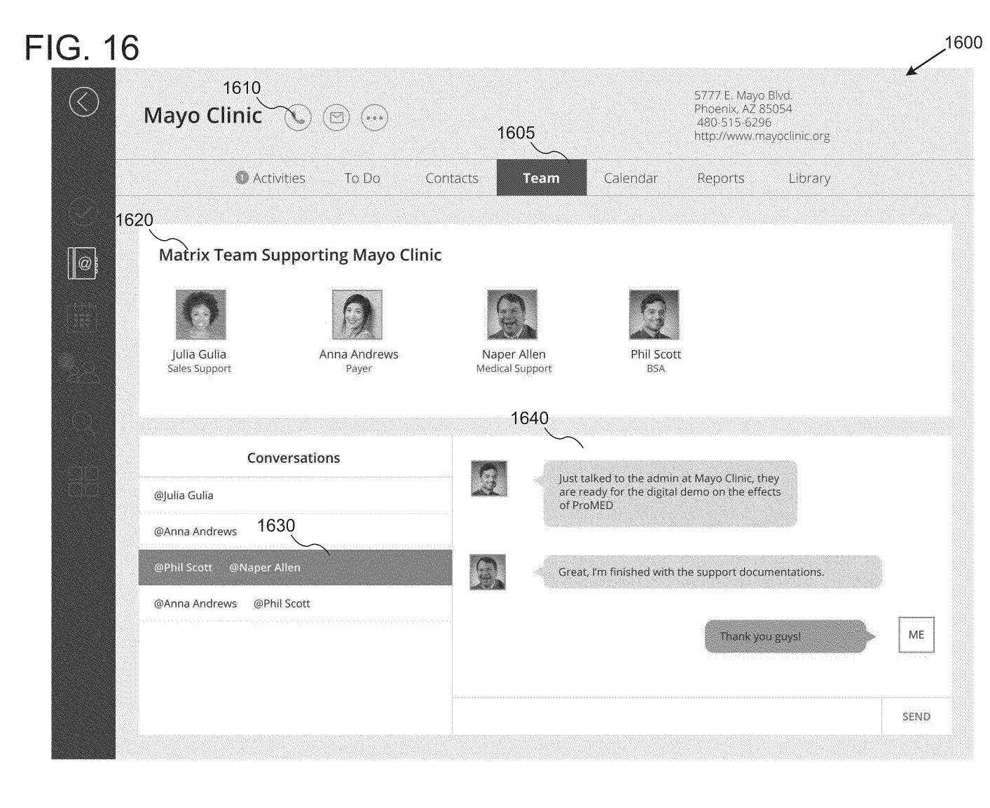

FIG. 16 illustrates an example interface 1600 for viewing associates that are associated with a particular customer, such as, in this example, the Mayo Clinic, because the “Team” control 1605 has been selected. The interface 1600 offers multiple presentations of information about the customer, including contact and interaction controls 1610, such as to email, call, or otherwise contact the customer. The interface 1600 also offers a listing 1620 of associates which are assigned to the customer. The interface 1600 also offers controls to view conversations. In the example of FIG. 16, the conversation 1630 has been selected, and the history 1640 of that conversation is shown to the user. In various embodiments, this conversation history may be limited to only those interactions having to do with the customer itself, or may include interactions relating to multiple customers.

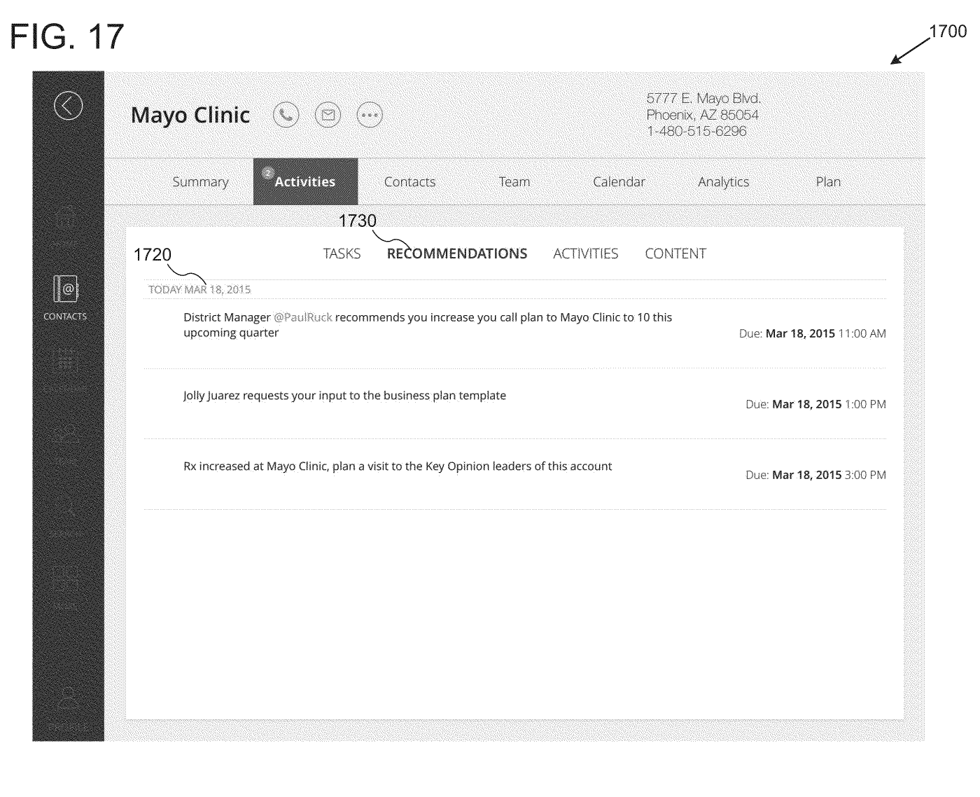

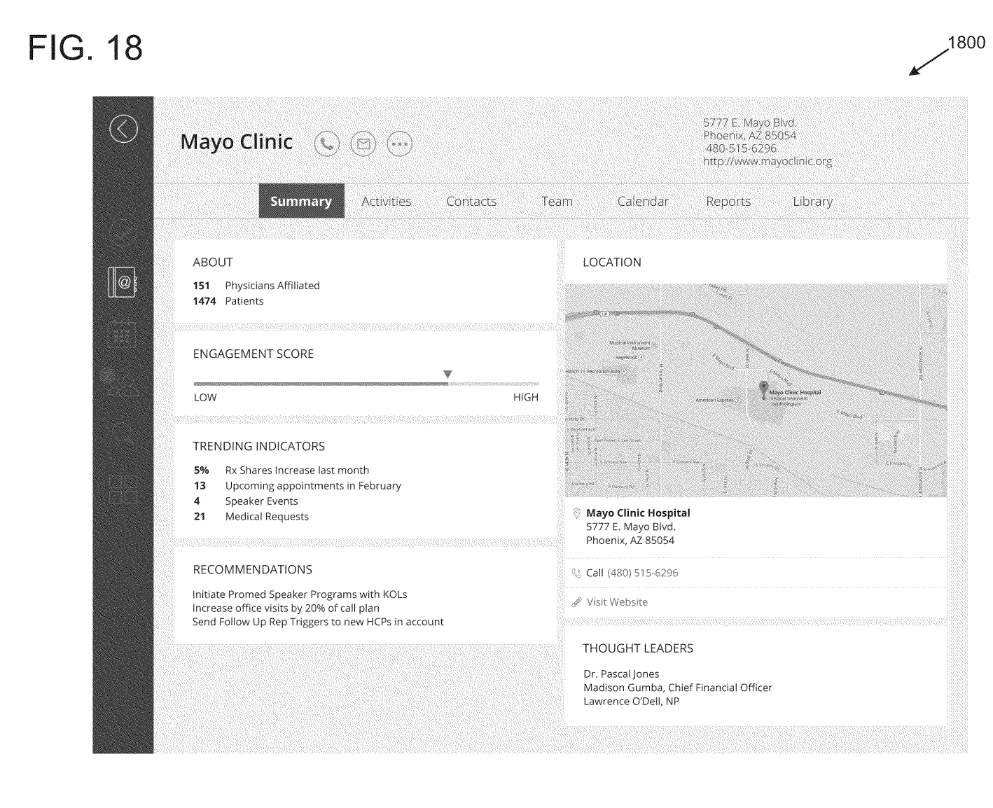

FIG. 17 illustrates an interface 1700 that includes a listing of activities that are planned for the particular customer. In FIG. 17, recommendations from associates to the associate viewing the information are shown in a list 1720. In each case, the interface 1700 presents the associate providing the recommendation, the time it was presented, and a due date for the recommendation. In various embodiments, actions, such as the recommendations shown in FIG. 17, may be provided by associates or other entities and provided during presentation of information. In various embodiments, these FIG. 18 illustrates an example interface 1800 providing summary information for the customer. In various embodiments, the summary information may include internal metrics, such as the illustrated “engagement score” and “trending indicators”, as well as demographic information, such as a location for the customer, contact information, as well as a listing of particular providers or other “Thought leaders” for the customer.

Referring now to FIG. 19, an example computer suitable for practicing various aspects of the present disclosure, including processes described herein, is illustrated in accordance with various embodiments. As shown, computer 1900 may include one or more processors or processor cores 1902, and system memory 1904. For the purpose of this application, including the claims, the terms “processor” and “processor cores” may be considered synonymous, unless the context clearly requires otherwise. Additionally, computer 1900 may include mass storage devices 1906 (such as diskette, hard drive, flash drive, solid state drive, compact disc read only memory (CD-ROM) and so forth), input/output devices 1908 (such as display, keyboard, cursor control, remote control, gaming controller, image capture device, and so forth) and communication interfaces 1910 (such as network interface cards, modems, infrared receivers, radio receivers (e.g., Bluetooth), and so forth). The elements may be coupled to each other via system bus 1912, which may represent one or more buses. In the case of multiple buses, they may be bridged by one or more bus bridges (not shown). Elements such as mass storage may be physically separate or remote.

Each of these elements may perform its conventional functions known in the art. In particular, system memory 1904 and mass storage devices 1906 may be employed to store a working copy and a permanent copy of the programming instructions implementing the operations associated with publishing of managed data as shown in processes described herein. The various elements may be implemented by assembler instructions supported by processor(s) 1902 or high-level languages, such as, for example, C, that can be compiled into such instructions.

The permanent copy of the programming instructions may be placed into permanent storage devices 1906 in the factory, or in the field, through, for example, a distribution medium (not shown), such as a compact disc (CD), or through communication interface 1910 (from a distribution server (not shown)). That is, one or more distribution media having an implementation of the processes described herein may be employed to distribute the programming instructions and program various computing devices.

The number, capability and/or capacity of these elements 1910-1912 may vary, depending on how computer 1900 is used. Their constitutions are otherwise known, and accordingly will not be further described.

FIG. 20 illustrates an example least one computer-readable storage medium 2002 having instructions configured to practice all or selected ones of the operations associated with techniques described herein. As illustrated, least one computer-readable storage medium 2002 may include a number of programming instructions 2004. Programming instructions 2004 may be configured to enable a device, e.g., computer 1900, in response to execution of the programming instructions, to perform, e.g., various operations of processes described herein, but not limited to, to the various operations performed to modify and share content. In alternate embodiments, programming instructions 2004 may be disposed on multiple computer-readable storage media 2002 instead.

Referring back to FIG. 19, for one embodiment, at least one of processors 1902 may be packaged together with computational logic 1922 configured to practice aspects of processes described herein. For one embodiment, at least one of processors 1902 may be packaged together with computational logic 1922 configured to practice aspects of processes of described herein to form a System in Package (SiP). For one embodiment, at least one of processors 1902 may be integrated on the same die with computational logic 1922 configured to practice aspects of processes of described herein. For one embodiment, at least one of processors 1902 may be packaged together with computational logic 1922 configured to practice aspects of processes of described herein to form a System on Chip (SoC). For at least one embodiment, the SoC may be utilized in, e.g., but not limited to, a computing tablet.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method for providing information regarding an organization, the method comprising:
receiving information, by a computing system, about the organization, from one or more information feeds, wherein the information feeds include static and dynamically updated information feeds;
receiving a selection of an entity, by the computing system, wherein the entity is associated with the organization;
presenting, by the computing system, organizational information associated with the entity to a user.

2. The method of claim 1, further comprising repeating receiving information, receiving a selection of an entity, and presenting as new information is provided in the one or more automated feeds.

3. The method of claim 1, further comprising determining if the user has been permitted to view information about the entity.

4. The method of claim 1, wherein presenting organization information comprises presenting an organizational structure for the organization.

5. The method of claim 4, wherein:
the entity is an associate of the organization; and
presenting the organizational structure comprises presenting a hierarchical structure of relationships between the selected entity and the one or more other associates within the organization.

6. The method of claim 5, wherein presenting organization information further comprises presenting demographic information regarding the associate.

7. The method of claim 1, wherein the entity is a customer of the organization an presenting organization information comprises presenting information regarding one or more associates who are assigned to interact with the customer.

8. The method of claim 7, wherein presenting information regarding one or more associates who are assigned to interact with the customer comprises presenting interactions between the one or more associates who are assigned to interact with the customer.

9. The method of claim 8, wherein presenting interactions comprises presenting interactions regarding the customer.

10. The method of claim 1, further comprising:
presenting, by the computing system, information received from the one or more automated information feeds to a reviewer; and
receiving, by the computing system, changes to the information received from the one or more automated information feeds.

11. The method of claim 1, wherein the entity is a geographical region, and presenting, organizational information comprises presenting associates assigned to that geographical region.

12. The method of claim 1, where the one or more automated information feeds comprises one or more of an organizational information feed or a messaging/interaction feed.

13. The method of claim 1, wherein presenting organization information comprises presenting one or more actions indicated for performance.

14. The method of claim 13, further comprising receiving from a user, by the computing system, information regarding the actions.

15. The method of claim 13, wherein presenting one or more actions comprises presenting one or more actions that are to be performed with relation to a customer.

16. One or more non-transitory computer-readable media containing instructions written thereon that, in response to execution on a computing system, cause the computing system to provide information regarding an organization by causing the computing system to:
receive information about the organization, from one or more information feeds, wherein the information feeds include static and dynamically updated information feeds;
receive a selection of an entity, wherein the entity is associated with the organization;
present organizational information associated with the entity to a user.

17. The one or more non-transitory computer-readable media of claim 16, wherein the instructions are further to cause the computing system to determine if the user has been permitted to view information about the entity.

18. The one or more non-transitory computer-readable media of claim 1, wherein present organization information comprises present an organizational structure for the organization.

19. The one or more non-transitory computer-readable media of claim 18, wherein:
the entity is an associate of the organization; and
present the organizational structure comprises present a hierarchical structure of relationships between the selected entity and the one or more other associates within the organization.

20. The one or more non-transitory computer-readable media of claim 16, wherein the entity is a customer of the organization an present organization information comprises present information regarding one or more associates who are assigned to interact with the customer.

21. The one or more non-transitory computer-readable media of claim 20, wherein present information regarding one or more associates who are assigned to interact with the customer comprises present interactions regarding the customer, the interactions being between the one or more associates who are assigned to interact with the customer.

22. The one or more non-transitory computer-readable media of claim 16, wherein present organization information comprises present one or more actions relating to a customer that are indicated for performance.

23. An apparatus for provision of information regarding an organization, the apparatus comprising:
one or more computing processors; and
one or more modules configured to operate on the one or more computing processors to:
receive information about the organization, from one or more information feeds, wherein the information feeds include static and dynamically updated information feeds;
receive a selection of an entity, wherein the entity is associated with the organization;
present organizational information associated with the entity to a user.

24. The apparatus of claim 23, wherein present organization information comprises present an organizational structure for the organization.

25. The apparatus of claim 24, wherein:
the entity is an associate of the organization; and
present the organizational structure comprises present a hierarchical structure of relationships between the selected entity and the one or more other associates within the organization.

26. The apparatus of claim 23, wherein the entity is a customer of the organization an present organization information comprises present information regarding one or more associates who are assigned to interact with the customer, including interactions regarding the customer, the interactions being between the one or more associates who are assigned to interact with the customer.
